(19) United States
(12) Patent Application Publication
(10) Pub. No.: US 2021/0263159 A1
(43) Pub. Date: Aug. 26, 2021

(54) INFORMATION PROCESSING METHOD, SYSTEM, DEVICE AND COMPUTER STORAGE MEDIUM

(71) Applicant: Beijing Baidu Netcom Science and Technology Co., Ltd. Beijing Baidu Netcom Science and Technology, Beijing (CN)

(72) Inventors: Xiaoxing ZHU, Beijing (CN); Xiang LIU, Beijing (CN); Fan YANG, Beijing (CN)

(21) Appl. No.: 17/251,169

(22) PCT Filed: Dec. 17, 2019
(86) PCT No.: PCT/CN2019/126008

§ 371 Date: Dec. 10, 2020

(30) Foreign Application Priority Data
Jan. 15, 2019 (CN) 201910034417.2

(51) Int. Cl. G01S 17/931; G01S 17/87; G01S 17/42; G01S 7/48; G01S 7/487; G06K 9/00; G06K 9/62

(52) U.S. Cl. CPC G01S 17/931; G01S 17/87; G01S 17/42; G06K 9/6289; G01S 7/487; G06K 9/00805; G01S 7/4802

(57) ABSTRACT

The present disclosure provides an information processing method, system, device and computer storage medium. The method comprises obtaining obstacle information acquired by an ultrasonic radar and a LiDAR respectively; fusing the obstacle information acquired by the LiDAR with the obstacle information acquired by the ultrasonic radar. The present disclosure avoids the problem that whether there is an obstacle laterally in front of or directly in front of the vehicle cannot be judged only according to the obstacle information returned by the ultrasonic radar, so that the driverless vehicle will stop automatically to avoid collision and its normal drive is affected, improves the obstacle recognition precision and ensures safe and stable drive of the driverless vehicle.

The present disclosure claims priority to the Chinese patent application No. 201910034417.2 entitled “Method and System for Fusing Information of Ultrasonic Radar and LiDAR” filed on the filing date Jan. 15, 2019, the entire disclosure of which is hereby incorporated by reference in its entirety.

### FIELD OF THE DISCLOSURE

The present disclosure relates to the field of automatic control, and particularly to an information processing method, system, device and computer storage medium.

### BACKGROUND OF THE DISCLOSURE

In a driverless vehicle are integrated many types of sensors such as a GPS-IMU (Global Positioning System-Inertial Measurement Unit) combination navigation module, a camera, a LiDAR (Light Detection and Ranging) and a millimeter wave radar.

Different types of sensors have different advantages and disadvantages. For example, LiDARs mounted at the front end of the center of the driverless vehicle are advantageous in a broad detection range, a higher precision of sensed data, and a far detectable distance in the longitudinal direction. Due to the principle of laser ranging, there is a detection blind region within a close distance range. To remedy blindness in the detection blind region, an ultrasonic radar and a forward LiDAR are generally mounted at the position of the front bumper of the vehicle body in the industry. When the ultrasonic radar measures a far target, its echo signal is weak and affects the measurement precision. However, in short-distance measurement, the ultrasonic radar has a very big advantage. However, on account of the problem with the measurement precision of the ultrasonic radar, a specific position of the obstacle cannot be depicted, for example, its FOA is 45 degrees; so long as there is an obstacle in the range, the ultrasonic radar returns the information about the obstacle, but the ultrasonic radar cannot determine a specific position of the obstacle in a detection sector, which might cause misjudgment and affects the driving of the driverless vehicle. For example, an obstacle on a lateral front side of the driverless vehicle does not affect travel, but it is impossible to judge according to the obstacle information returned by the ultrasonic radar whether the obstacle is on the lateral front side or directly in front of the driverless vehicle, so the driverless vehicle automatically stops to avoid collision and normal driving is affected.

### SUMMARY OF THE DISCLOSURE

Aspects of the present disclosure provide an information processing method, system, device and computer storage medium, to reduce the misjudgment caused by the ultrasonic radar.

An aspect of the present disclosure provides an information processing method, comprising:

obtaining obstacle information acquired by an ultrasonic radar and a LiDAR respectively;

fusing the obstacle information acquired by the LiDAR with the obstacle information acquired by the ultrasonic radar.

The above aspect and any possible implementation further provides an implementation: the ultrasonic radar is mounted at the front of a vehicle body of the driverless vehicle and used to detect obstacle information in front of and laterally in front of the vehicle;

the LiDAR is mounted at the front of the vehicle body of the driverless vehicle and used to detect the obstacle information in front of and laterally in front of the vehicle.

The above aspect and any possible implementation further provides an implementation: the fusing the obstacle information acquired by the LiDAR with the obstacle information acquired by the ultrasonic radar comprises:

unifying coordinates in a LiDAR coordinate system and coordinates in an ultrasonic radar coordinate system into a reference coordinate system;

superimposing the unified LiDAR coordinates and ultrasonic radar coordinates in a gridded detection overlapping region;

fusing the superimposed LiDAR coordinates and ultrasonic radar coordinates.

The above aspect and any possible implementation further provides an implementation: the reference coordinate system is a geodetic coordinate system or a vehicle coordinate system.

The above aspect and any possible implementation further provides an implementation: the superimposing the unified LiDAR coordinates and ultrasonic radar coordinates in a gridded detection overlapping region comprises:

gridding the obstacle recognition result in the detection overlapping region, and superimposing the unified LiDAR coordinates and ultrasonic radar coordinates into the in the grids.

The above aspect and any possible implementation further provides an implementation: the fusing the superimposed LiDAR coordinates and ultrasonic radar coordinates comprises:

judging that a grid having the LiDAR coordinates as well as ultrasonic radar coordinates is occupied; judging that a grid only having the ultrasonic radar coordinates is not occupied.

The above aspect and any possible implementation further provides an implementation: the method further comprises:

outside the detection overlapping regions, recognizing the obstacle according to the LiDAR coordinates or ultrasonic radar coordinates, respectively.

The above aspect and any possible implementation further provides an implementation: the method further comprises:

determining a vehicle decision according to the fused obstacle information.

Another aspect of the present disclosure provides an information processing system, comprising:

an obtaining module configured to obtain obstacle information acquired by an ultrasonic radar and a LiDAR respectively;

a fusing module configured to fuse the obstacle information acquired by the LiDAR with the obstacle information acquired by the ultrasonic radar.

The above aspect and any possible implementation further provides an implementation: the ultrasonic radar is mounted at the front of a vehicle body of the driverless vehicle and used to detect obstacle information in front of and laterally in front of the vehicle;

the LiDAR is mounted at the front of the vehicle body of the driverless vehicle and used to detect the obstacle information in front of and laterally in front of the vehicle.

The above aspect and any possible implementation further provides an implementation: the fusing module comprises:

a unifying submodule configured to unify coordinates in a LiDAR coordinate system and coordinates in an ultrasonic radar coordinate system into a reference coordinate system;

a superimposing submodule configured to superimpose the unified LiDAR coordinates and ultrasonic radar coordinates in a gridded detection overlapping region;

a fusing submodule configured to fuse the superimposed LiDAR coordinates and ultrasonic radar coordinates.

The above aspect and any possible implementation further provides an implementation: the reference coordinate system is a geodetic coordinate system or a vehicle coordinate system.

The above aspect and any possible implementation further provides an implementation: the superimposing submodule is specifically configured to:

grid the obstacle recognition result in the detection overlapping region, and superimpose the unified LiDAR coordinates and ultrasonic radar coordinates into the in the grids.

The above aspect and any possible implementation further provides an implementation: the fusing submodule is specifically configured to:

judge that a grid having the LiDAR coordinates as well as ultrasonic radar coordinates is occupied; judge that a grid only having the ultrasonic radar coordinates is not occupied.

The above aspect and any possible implementation further provides an implementation: the system is further configured to:

outside the detection overlapping regions, recognize the obstacle according to the LiDAR coordinates or ultrasonic radar coordinates, respectively.

The above aspect and any possible implementation further provides an implementation: the system further comprises a decision-making module configured to determine a vehicle decision according to the fused obstacle information.

A further aspect of the present invention provides a computer device, comprising a memory, a processor and a computer program which is stored on the memory and runs on the processor, the processor, upon executing the program, implementing the above-mentioned method.

A further aspect of the present invention provides a computer-readable storage medium on which a computer program is stored, the program, when executed by the processor, implementing the aforesaid method.

As known from the above technical solutions, in the embodiments of the present disclosure, it is possible to, by fusing the LiDAR coordinates with the ultrasonic radar coordinates, avoid the case that ultrasonic radar can only judge the obstacle distance and cannot judge the impact exerted by the obstacle direction on the travel of the driverless vehicle, thereby improving the obstacle recognition precision and ensuring safe and stable drive of the driverless vehicle.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts.

FIG. 1 is a flow chart of an information processing method according to an embodiment of the present disclosure;

FIG. 2 is a structural schematic diagram of an information processing system according to an embodiment of the present disclosure;

FIG. 3 illustrates a block diagram of an example computer system/server 012 adapted to implement an implementation mode of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

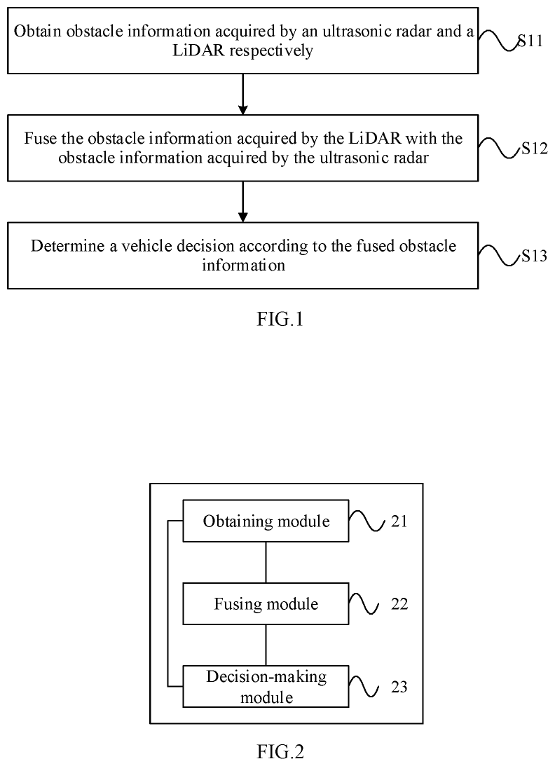

FIG. 1 is a flow chart of an information processing method according to an embodiment of the present disclosure. As shown in FIG. 1, the method comprises the following steps:

Step S11: obtaining obstacle information acquired by an ultrasonic radar and a LiDAR respectively;

Step S12: fusing the obstacle information acquired by the LiDAR and the obstacle information acquired by the ultrasonic radar to determine an obstacle recognition result.

In a preferred implementation mode of Step S11,

In the present embodiment, the LiDAR is a single-line LiDAR, and mounted at the front of the driverless vehicle, e.g., at the center of an intake grill at a height about 40 cm; the single-line LiDAR only has one transmitting path and one receiving path, and exhibits a relatively simple structure, convenient use, low costs, a high scanning speed, a high angular resolution and flexible range finding; the single-line LiDAR is more advantageous than multi-line LiDAR in aspects such as pedestrian detection, obstacle detection (small target detection) and detection of a front obstacle because the angular resolution of the single-line LiDAR may be made higher than the multi-line LiDAR, which is very useful in detecting the small object or pedestrian. Since the angular resolution of the single-line LiDAR may be made higher than the multi-line LiDAR, the pedestrian may be discovered in advance at a farther distance, and more early warning time may be left for the control system. The detection region of the single-line LiDAR is 0.5-8 m in front of and laterally in front of the vehicle body of the driverless vehicle. The ultrasonic radars are symmetrically distributed with 3 ultrasonic radars on each of left and right sides in front of the vehicle, and their detection region is 0-3.5 m in front of and laterally in front of the vehicle body of the driverless vehicle.

In the present embodiment, an electronic device (e.g., a vehicle-mounted computer or vehicle-mounted terminal) on which the method of fusing the information acquired by the ultrasonic radar with the information acquired by the LiDAR runs may control the LiDAR and the ultrasonic radar in a wired or wireless connection manner. Specifically, the vehicle-mounted computer or vehicle-mounted terminal may control the LiDAR to acquire laser point cloud data of a certain region at a certain frequency, and control the ultrasonic radar to acquire echo data of a certain region at a certain frequency. The above target region may be a region where the obstacle to be detected lies.

It needs to be appreciated that the wireless connection manner may include but not limited to 3G/4G connection, WiFi connection, Bluetooth connection, WiMAX connection, Zigbee connection, UWB (ultra wideband) connection, and other currently-known or future-developed wireless connection manners.

The point cloud information data of the obstacle within a 0.5-8 m range ahead that may be acquired by the LiDAR is set to perform real-time update of the position of the obstacle in the detection region and the distance.

The LiDAR acquires the LiDAR point cloud information of the obstacle in front of the vehicle. The LiDAR rotates uniformly at a certain angular speed. During the process, laser is constantly emitted and information of a reflection point is collected to obtain omnidirectional environment information. While collecting the distance of the reflection point, the LiDAR meanwhile records the time of occurrence at this point and a horizontal angle, each laser emitter has a serial number and a fixed vertical angle, and coordinates of all reflection points may be calculated according to these data. A set of coordinates of all reflection points collected by the LiDAR upon each revolution forms the point cloud.

The interference in the laser point cloud is filtered away with a filter, and the target is detected by a mode clustering analysis method according to shape spatial position features of the target; a method of adjusting a distance threshold is used to re-combine sub-groups divided from the clustering, determine a new clustering center to implement the positioning of the target, and obtain the coordinates of the target.

Alternatively, information related to the obstacle, including parameters such as distance, azimuth, height, speed, posture and shape is obtained after using a preset point cloud recognition model to recognize the obstacle in the point cloud data. Therefore, the coordinate information of the obstacles in front of and laterally in front of the driverless vehicle is obtained. The preset point cloud recognition model may be various pre-trained algorithms capable of recognizing the obstacle in the point cloud data, for example, may be an ICP (Iterative Closest Point) algorithm, an random forest algorithm etc.

The ultrasonic radar obtains echo information of obstacles in front of and laterally in front of the vehicle. The ultrasonic radar may obtain the echo information data of the obstacles within a 0-3.5 m close distance range. The echo information data is a differential value t between time of sending the ultrasonic wave and time of receiving a reflected wave, and a distance s=340t/2 between the ultrasonic radar and the obstacle may be calculated according to the differential value t. Thereby, the distance information data of the obstacle is obtained.

Data fusion may be performed after acquiring the laser point cloud information of the obstacles in front of and laterally in front of the vehicle through the LiDAR and acquiring the distance information of the obstacles in front of and laterally in front of the vehicle through the ultrasonic radar.

In a preferred implementation mode of Step S12,

Step S12 comprises the following substeps:

Substep S121: unifying coordinates in a LiDAR coordinate system and coordinates in an ultrasonic radar coordinate system into a reference coordinate system.

Since mounting positions of a plurality of sensors of the LiDARs and ultrasonic radars are different, it is necessary to select a reference coordinate system to convert coordinates in the LiDAR coordinate system and coordinates of each ultrasonic radar coordinate system into the reference coordinate system. In the present embodiment, the coordinates in the LiDAR coordinate system and coordinates in the ultrasonic radar coordinate system may be unified and converted into a geodetic coordinate system.

Initial spatial configurations of the LiDAR and ultrasonic radar on the driverless vehicle are already known in advance, and may be obtained according to measurement data thereof on the vehicle body of the driverless vehicle. The coordinates of the obstacle in respective coordinate systems are converted into a consistent geodetic coordinate system.

Preferably, the driverless vehicle may further comprise a position and orientation system for acquiring position information and posture information of the position and orientation system, namely, the coordinates thereof in the geodetic coordinate system. The position information and posture information of the position and orientation system are used to combine with the LiDAR coordinates to obtain spatial coordinate data of the obstacle, and combine with the ultrasonic radar coordinates to obtain spatial distance data of the obstacle.

Exemplarily, the position and orientation system may comprise a GPS positioning device and an IMU for acquiring the position information and posture information of the position and orientation system respectively. The position information may include central coordinates (x, y, z) of the position and orientation system, and the posture information may include three posture angles (ω, κ) of the position and orientation system. The relative positions between the position and orientation system and LiDAR are constant, so the position information and posture information of the LiDAR may be determined according to the position information and posture information of the position and orientation system. Then, 3D laser scanned data may be corrected according to the position information and posture information of the LiDAR to determine the spatial coordinate data of the obstacle. The relative positions between the position and orientation system and the ultrasonic probes of the ultrasonic radars are constant, so the position information and the posture information of the ultrasonic probes may be determined according to the position information and posture information of the position and orientation system. Then, ultrasonic distance data may be corrected according to the position information and posture information of the ultrasonic probes to determine spatial distance data of the obstacle.

The LiDAR coordinates and the ultrasonic radar coordinates are unified through the above conversion to lay a foundation for coordinate fusion.

In a preferred implementation of the present embodiment, the LiDAR coordinates and the ultrasonic radar coordinates may be unified to a vehicle coordinate system, including LiDAR point cloud coordinate conversion. A matrix relationship between the LiDAR coordinate system and the vehicle coordinate system is calibrated through the initial space configuration of the LiDAR on the driverless vehicle. During the installation of the LiDAR, the coordinates of the LiDAR is angularly offset from the vehicle coordinates in 3D space, and conversion needs to be performed by modifying the matrix. The matrix is converted according to the relationship between the initial spatial configuration of each ultrasonic radar on the driverless vehicle and the vehicle coordinate system.

Substep S122: superimposing the unified LiDAR coordinates and ultrasonic radar coordinates in a gridded detection overlapping region.

Since the detection regions of the LiDAR and ultrasonic radar are different, the detection overlapping regions of the LiDAR and ultrasonic radars are fused to determine an obstacle recognition result.

Preferably, outside the detection overlapping regions, the obstacle is still recognized according to the respective coordinates.

Preferably, the detection overlapping region is within a range of 0.5-3.5 m in front of and laterally in front of the vehicle body, the obstacle recognition result in the detection overlapping region is gridded, and a grid attribute is set. Preferably, the detection precision of the LiDAR is ±3 cm, the precision of the distance detected by the ultrasonic radar is 10 cm, and the grid is set as a unit grid having the size 20 cm×20 cm with the total number of grids being considered.

The LiDAR coordinates and ultrasonic radar coordinates unified into the geodetic coordinate system or vehicle coordinate system are superimposed in the grids.

Substep S123: fusing the superimposed LiDAR coordinates and ultrasonic radar coordinates to determine an obstacle recognition result.

In the present embodiment, the coordinates output by the ultrasonic radar are distance data of the obstacle, namely, a circular arc range with the ultrasonic radar as a center of a circle and with the distance data as a radius is totally recognized by the ultrasonic radar as the obstacle. However, the obstacle in fact might be located at any point or more points on the circular arc range. In this case, it is necessary to judge which point on the circular arc range the obstacle is specifically located through the LiDAR coordinates.

Preferably, the following judgment manner is employed: judging that a grid point having the LiDAR coordinates as well as ultrasonic radar coordinates is occupied; judging that a grid point only having the ultrasonic radar coordinates is not occupied. This avoids occurrence of the case in which outputting the entire circular arc when the obstacle is located on a side of the driverless vehicle causes the driverless vehicle to believe there is an obstacle ahead and brake to avoid the obstacle. If the grid point of the detection overlapping region is not occupied, it is believed that the obstacle is located at a portion that the circular arc range is located outside the detection overlapping region.

Preferably, the method further comprises the following step S13: determining a vehicle decision according to the fused obstacle information.

Preferably, the vehicle decision is determined according to the post-fusion obstacle recognition result in the detection overlapping region and the obstacle recognition result outside the detection overlapping region. If there is an obstacle in front of the vehicle, the vehicle is controlled to decelerate. If there is an obstacle laterally in front of the vehicle, the vehicle continues to drive.

It is possible to, through the solution of the present embodiment, avoid the problem that whether there is an obstacle laterally in front of or directly in front of the vehicle cannot be judged only according to the obstacle information returned by the ultrasonic radar, so that the driverless vehicle will stop automatically to avoid collision and its normal drive is affected, and possible to improve the obstacle recognition precision and ensure safe and stable drive of the driverless vehicle.

In a preferred implementation of the present embodiment, during the drive of the driverless vehicle, only in the case that the obstacle information returned by the ultrasonic radar affects the normal travel of the driverless vehicle, the obstacle information acquired by the LiDAR is fused with the obstacle information acquired by the ultrasonic radar, to determine the obstacle recognition result, to reduce the amount of operation of the system and improve the response speed.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

The above introduces the method embodiments. The solution of the present disclosure will be further described through an apparatus embodiment.

FIG. 2 is a structural schematic diagram of an information processing system according to an embodiment of the present disclosure. As shown in FIG. 2, the system comprises:

an obtaining module 21 configured to obtain obstacle information acquired by an ultrasonic radar and a LiDAR respectively;

a fusing module 22 configured to fuse the obstacle information acquired by the LiDAR with the obstacle information acquired by the ultrasonic radar to determine an obstacle recognition result.

In a preferred implementation mode of the obtaining module 21,

In the present embodiment, the LiDAR is a single-line LiDAR, and mounted at the front of the driverless vehicle, e.g., at the center of an intake grill at a height about 40 cm; the single-line LiDAR only has one transmitting path and one receiving path, and exhibits a relatively simple structure, convenient use, low costs, a high scanning speed, a high angular resolution and flexible range finding; the single-line LiDAR is more advantageous than multi-line LiDAR in aspects such as pedestrian detection, obstacle detection (small target detection) and detection of a front obstacle because the angular resolution of the single-line LiDAR may be made higher than the multi-line LiDAR, which is very useful in detecting the small object or pedestrian. Since the angular resolution of the single-line LiDAR may be made higher than the multi-line LiDAR, the pedestrian may be discovered in advance at a farther distance, and more early warning time may be left for the control system. The detection region of the single-line LiDAR is 0.5-8 m in front of and laterally in front of the vehicle body of the driverless vehicle. The ultrasonic radars are symmetrically distributed with 3 ultrasonic radars on each of left and right sides in front of the vehicle, and their detection region is 0-3.5 m in front of and laterally in front of the vehicle body of the driverless vehicle.

In the present embodiment, an electronic device (e.g., a vehicle-mounted computer or vehicle-mounted terminal) on which the method of fusing the information acquired by the ultrasonic radar with the information acquired by the LiDAR runs may control the LiDAR and the ultrasonic radar in a wired or wireless connection manner. Specifically, the vehicle-mounted computer or vehicle-mounted terminal may control the LiDAR to acquire laser point cloud data of a certain region at a certain frequency, and control the ultrasonic radar to acquire echo data of a certain region at a certain frequency. The above target region may be a region where the obstacle to be detected lies.

It needs to be appreciated that the wireless connection manner may include but not limited to 3G/4G connection, WiFi connection, Bluetooth connection, WiMAX connection, Zigbee connection, UWB (ultra wideband) connection, and other currently-known or future-developed wireless connection manners.

The point cloud information data of the obstacle within a 0.5-8 m range ahead that may be acquired by the LiDAR is set to perform real-time update of the position of the obstacle in the detection region and the distance.

The LiDAR acquires the LiDAR point cloud information of the obstacle in front of the vehicle. The LiDAR rotates uniformly at a certain angular speed. During the process, laser is constantly emitted and information of a reflection point is collected to obtain omnidirectional environment information. While collecting the distance of the reflection point, the LiDAR meanwhile records the time of occurrence at this point and a horizontal angle, each laser emitter has a serial number and a fixed vertical angle, and coordinates of all reflection points may be calculated according to these data. A set of coordinates of all reflection points collected by the LiDAR upon each revolution forms the point cloud.

The interference in the laser point cloud is filtered away with a filter, and the target is detected by a mode clustering analysis method according to shape spatial position features of the target; a method of adjusting a distance threshold is used to re-combine sub-groups divided from the clustering, determine a new clustering center to implement the positioning of the target, and obtain the coordinates of the target.

Alternatively, information related to the obstacle, including parameters such as distance, azimuth, height, speed, posture and shape is obtained after using a preset point cloud recognition model to recognize the obstacle in the point cloud data. Therefore, the coordinate information of the obstacles in front of and laterally in front of the driverless vehicle is obtained. The preset point cloud recognition model may be various pre-trained algorithms capable of recognizing the obstacle in the point cloud data, for example, may be an ICP (Iterative Closest Point) algorithm, an random forest algorithm etc.

The ultrasonic radar obtains echo information of obstacles in front of and laterally in front of the vehicle. The ultrasonic radar may obtain the echo information data of the obstacles within a 0-3.5 m close distance range. The echo information data is a differential value t between time of sending the ultrasonic wave and time of receiving a reflected wave, and a distance s=340t/2 between the ultrasonic radar and the obstacle may be calculated according to the differential value t. Thereby, the distance information data of the obstacle is obtained.

Data fusion may be performed after acquiring the laser point cloud information of the obstacles in front of and laterally in front of the vehicle through the LiDAR and acquiring the distance information of the obstacles in front of and laterally in front of the vehicle through the ultrasonic radar.

In a preferred implementation mode of the fusing module 22,

The fusing module 22 comprises the following submodules:

a unifying submodule configured to unify coordinates in a LiDAR coordinate system and coordinates in an ultrasonic radar coordinate system into a reference coordinate system.

Since mounting positions of a plurality of sensors of the LiDARs and ultrasonic radars are different, it is necessary to select a reference coordinate system to convert coordinates in the LiDAR coordinate system and coordinates of each ultrasonic radar coordinate system into the reference coordinate system. In the present embodiment, the coordinates in the LiDAR coordinate system and coordinates in the ultrasonic radar coordinate system may be unified and converted into a geodetic coordinate system.

Initial spatial configurations of the LiDAR and ultrasonic radar on the driverless vehicle are already known in advance, and may be obtained according to measurement data thereof on the vehicle body of the driverless vehicle. The coordinates of the obstacle in respective coordinate systems are converted into a consistent geodetic coordinate system.

Preferably, the driverless vehicle may further comprise a position and orientation system for acquiring position information and posture information of the position and orientation system, namely, the coordinates thereof in the geodetic coordinate system. The position information and posture information of the position and orientation system are used to combine with the LiDAR coordinates to obtain spatial coordinate data of the obstacle, and combine with the ultrasonic radar coordinates to obtain spatial distance data of the obstacle.

Exemplarily, the position and orientation system may comprise a GPS positioning device and an IMU for acquiring the position information and posture information of the position and orientation system respectively. The position information may include central coordinates (x, y, z) of the position and orientation system, and the posture information may include three posture angles (ω, κ) of the position and orientation system. The relative positions between the position and orientation system and LiDAR are constant, so the position information and posture information of the LiDAR may be determined according to the position information and posture information of the position and orientation system. Then, 3D laser scanned data may be corrected according to the position information and posture information of the LiDAR to determine the spatial coordinate data of the obstacle. The relative positions between the position and orientation system and the ultrasonic probes of the ultrasonic radars are constant, so the position information and the posture information of the ultrasonic probes may be determined according to the position information and posture information of the position and orientation system. Then, ultrasonic distance data may be corrected according to the position information and posture information of the ultrasonic probes to determine spatial distance data of the obstacle.

The LiDAR coordinates and the ultrasonic radar coordinates are unified through the above conversion to lay a foundation for coordinate fusion.

In a preferred implementation of the present embodiment, the LiDAR coordinates and the ultrasonic radar coordinates may be unified to a vehicle coordinate system, including LiDAR point cloud coordinate conversion. A matrix relationship between the LiDAR coordinate system and the vehicle coordinate system is calibrated through the initial space configuration of the LiDAR on the driverless vehicle. During the installation of the LiDAR, the coordinates of the LiDAR is angularly offset from the vehicle coordinates in 3D space, and conversion needs to be performed by modifying the matrix. The matrix is converted according to the relationship between the initial spatial configuration of each ultrasonic radar on the driverless vehicle and the vehicle coordinate system.

A superimposing submodule configured to superimpose the unified LiDAR coordinates and ultrasonic radar coordinates in a gridded detection overlapping region.

Since the detection regions of the LiDAR and ultrasonic radar are different, the detection overlapping regions of the LiDAR and ultrasonic radars are fused to determine an obstacle recognition result.

Preferably, outside the detection overlapping regions, the obstacle is still recognized according to the respective coordinates.

Preferably, the detection overlapping region is within a range of 0.5-3.5 m in front of and laterally in front of the vehicle body, the obstacle recognition result in the detection overlapping region is gridded, and a grid attribute is set. Preferably, the detection precision of the LiDAR is ±3 cm, the precision of the distance detected by the ultrasonic radar is 10 cm, and the grid is set as a unit grid having the size 20 cm×20 cm with the total number of grids being considered.

The LiDAR coordinates and ultrasonic radar coordinates unified into the geodetic coordinate system or vehicle coordinate system are superimposed in the grids.

A fusing submodule configured to fuse the superimposed LiDAR coordinates and ultrasonic radar coordinates.

In the present embodiment, the coordinates output by the ultrasonic radar are distance data of the obstacle, namely, a circular arc range with the ultrasonic radar as a center of a circle and with the distance data as a radius is totally recognized by the ultrasonic radar as the obstacle. However, the obstacle in fact might be located at any point or more points on the circular arc range. In this case, it is necessary to judge which point on the circular arc range the obstacle is specifically located through the LiDAR coordinates.

Preferably, the following judgment manner is employed: judging that a grid point having the LiDAR coordinates as well as ultrasonic radar coordinates is occupied; judging that a grid point only having the ultrasonic radar coordinates is not occupied. This avoids occurrence of the case in which outputting the entire circular arc when the obstacle is located on a side of the driverless vehicle causes the driverless vehicle to believe there is an obstacle ahead and brake to avoid the obstacle. If the grid point of the detection overlapping region is not occupied, it is believed that the obstacle is located at a portion that the circular arc range is located outside the detection overlapping region.

Preferably, the method further comprises a decision-making module 23 configured to determine a vehicle decision according to the fused obstacle information.

Preferably, the vehicle decision is determined according to the post-fusion obstacle recognition result in the detection overlapping region and the obstacle recognition result outside the detection overlapping region. If there is an obstacle in front of the vehicle, the vehicle is controlled to decelerate. If there is an obstacle laterally in front of the vehicle, the vehicle continues to drive.

It is possible to, through the solution of the present embodiment, avoid the problem that whether there is an obstacle laterally in front of or directly in front of the vehicle cannot be judged only according to the obstacle information returned by the ultrasonic radar, so that the driverless vehicle will stop automatically to avoid collision and its normal drive is affected, and possible to improve the obstacle recognition precision and ensure safe and stable drive of the driverless vehicle.

In a preferred implementation of the present embodiment, during the drive of the driverless vehicle, only in the case that the obstacle information returned by the ultrasonic radar affects the normal travel of the driverless vehicle, the obstacle information acquired by the LiDAR is fused with the obstacle information acquired by the ultrasonic radar, to determine the obstacle recognition result, to reduce the amount of operation of the system and improve the response speed.

In the above embodiments, embodiments are respectively described with different emphasis being placed, and reference may be made to related depictions in other embodiments for portions not detailed in a certain embodiment.

In the embodiments provided by the present invention, it should be understood that the revealed method and apparatus may be implemented in other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be performed via some interfaces, and indirect coupling or communicative connection of means or units may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present invention, functional units can be integrated in one processing unit, or they can be separate physical presences; or two or more units can be integrated in one unit. The integrated unit described above can be realized in the form of hardware, or they can be realized with hardware and software functional units.

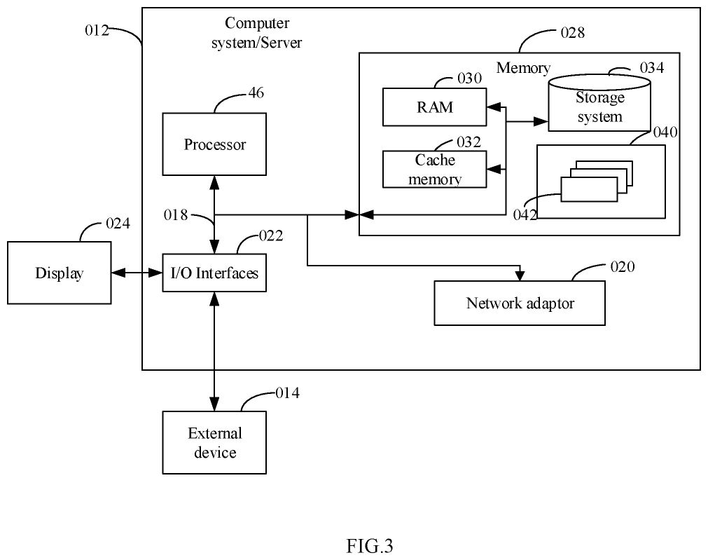

FIG. 3 illustrates a block diagram of an example computer system/server 012 adapted to implement an implementation mode of the present disclosure. The computer system/server 012 shown in FIG. 3 is only an example, and should not bring any limitation to the functions and use scope of the embodiments of the present disclosure.

As shown in FIG. 3, the computer system/server 012 is shown in the form of a general-purpose computing device. The components of the computer system/server 012 may include, but are not limited to, one or more processors or processing units 016, a system memory 028, and a bus 018 that couples various system components including the system memory 028 and the processing unit 016.

Bus 018 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 012 typically includes a variety of computer system readable media. Such media may be any available media that is accessible by computer system/server 012, and it includes both volatile and non-volatile media, removable and non-removable media.

Memory 028 can include computer system readable media in the form of volatile memory, such as random access memory (RAM) 030 and/or cache memory 032. Computer system/server 012 may further include other removable/non-removable, volatile/non-volatile computer system storage media. By way of example only, storage system 034 can be provided for reading from and writing to a non-removable, non-volatile magnetic media (not shown in FIG. 3 and typically called a “hard drive”). Although not shown in FIG. 3, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 018 by one or more data media interfaces. The memory 028 may include at least one program product having a set of (e.g., at least one) program modules that are configured to carry out the functions of embodiments of the present disclosure.

Program/utility 040, having a set of (at least one) program modules 042, may be stored in the system memory 028 by way of example, and not limitation, as well as an operating system, one or more disclosure programs, other program modules, and program data. Each of these examples or a certain combination thereof might include an implementation of a networking environment. Program modules 042 generally carry out the functions and/or methodologies of embodiments of the present disclosure.

Computer system/server 012 may also communicate with one or more external devices 014 such as a keyboard, a pointing device, a display 024, etc.; with one or more devices that enable a user to interact with computer system/server 012; and/or with any devices (e.g., network card, modem, etc.) that enable computer system/server 012 to communicate with one or more other computing devices. Such communication can occur via Input/Output (I/O) interfaces 022. Still yet, computer system/server 012 can communicate with one or more networks such as a local area network (LAN), a general wide area network (WAN), and/or a public network (e.g., the Internet) via network adapter 020. As shown in the figure, network adapter 020 communicates with the other communication modules of computer system/server 012 via bus 018. It should be understood that although not shown in FIG. 3, other hardware and/or software modules could be used in conjunction with computer system/server 012. Examples, include, but are not limited to: microcode, device drivers, redundant processing units, external disk drive arrays, RAID systems, tape drives, and data archival storage systems, etc.

The processing unit 016 executes the functions and/or methods described in the embodiments of the present disclosure by running the programs stored in the system memory 028.

The aforesaid computer program may be arranged in the computer storage medium, namely, the computer storage medium is encoded with the computer program. The computer program, when executed by one or more computers, enables one or more computers to execute the flow of the method and/or operations of the apparatus as shown in the above embodiments of the present disclosure.

As time goes by and technologies develop, the meaning of medium is increasingly broad. A propagation channel of the computer program is no longer limited to tangible medium, and it may also be directly downloaded from the network. The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not make essence of corresponding technical solutions depart from the spirit and scope of technical solutions of embodiments of the present disclosure.

1.-18. (canceled)

19. An information processing method, wherein the method comprises:
obtaining obstacle information acquired by an ultrasonic radar and a LiDAR respectively;
fusing the obstacle information acquired by the LiDAR with the obstacle information acquired by the ultrasonic radar.

20. The method according to claim 19, wherein
the ultrasonic radar is mounted at the front of a vehicle body of the driverless vehicle and used to detect obstacle information in front of and laterally in front of the vehicle;
the LiDAR is mounted at the front of the vehicle body of the driverless vehicle and used to detect the obstacle information in front of and laterally in front of the vehicle.

21. The method according to claim 19, wherein the fusing the obstacle information acquired by the LiDAR with the obstacle information acquired by the ultrasonic radar comprises:
unifying coordinates in a LiDAR coordinate system and coordinates in an ultrasonic radar coordinate system into a reference coordinate system;
superimposing the unified LiDAR coordinates and ultrasonic radar coordinates in a gridded detection overlapping region;
fusing the superimposed LiDAR coordinates and ultrasonic radar coordinates to determine an obstacle recognition result.

22. The method according to claim 21, wherein the reference coordinate system is a geodetic coordinate system or a vehicle coordinate system.

23. The method according to claim 21, wherein the superimposing the unified LiDAR coordinates and ultrasonic radar coordinates in a gridded detection overlapping region comprises:
gridding the obstacle recognition result in the detection overlapping region, and superimposing the unified LiDAR coordinates and ultrasonic radar coordinates into the in the grids.

24. The method according to claim 23, wherein the fusing the superimposed LiDAR coordinates and ultrasonic radar coordinates comprises:
judging that a grid having the LiDAR coordinates as well as ultrasonic radar coordinates is occupied; judging that a grid only having the ultrasonic radar coordinates is not occupied.

25. The method according to claim 21, wherein the method further comprises:
for a region outside the detection overlapping regions, recognizing the obstacle according to the LiDAR coordinates or ultrasonic radar coordinates, respectively.

26. The method according to claim 19, wherein the method further comprises:
determining a vehicle decision according to the fused obstacle information.

27. An electronic device, comprising:
at least one processor; and
a memory communicatively connected with the at least one processor;
wherein the memory stores instructions executable by the at least one processor, and the instructions are executed by the at least one processor to enable the at least one processor to perform an information processing method, wherein the information processing method comprises:
obtaining obstacle information acquired by an ultrasonic radar and a LiDAR respectively;
fusing the obstacle information acquired by the LiDAR with the obstacle information acquired by the ultrasonic radar.

28. The electronic device according to claim 27, wherein
the ultrasonic radar is mounted at the front of a vehicle body of the driverless vehicle and used to detect obstacle information in front of and laterally in front of the vehicle;
the LiDAR is mounted at the front of the vehicle body of the driverless vehicle and used to detect the obstacle information in front of and laterally in front of the vehicle.

29. The electronic device according to claim 27, wherein the fusing the obstacle information acquired by the LiDAR with the obstacle information acquired by the ultrasonic radar comprises:
unifying coordinates in a LiDAR coordinate system and coordinates in an ultrasonic radar coordinate system into a reference coordinate system;
superimposing the unified LiDAR coordinates and ultrasonic radar coordinates in a gridded detection overlapping region;
fusing the superimposed LiDAR coordinates and ultrasonic radar coordinates to determine an obstacle recognition result.

30. The electronic device according to claim 29, wherein the reference coordinate system is a geodetic coordinate system or a vehicle coordinate system.

31. The electronic device according to claim 29, wherein the superimposing the unified LiDAR coordinates and ultrasonic radar coordinates in a gridded detection overlapping region comprises:
gridding the obstacle recognition result in the detection overlapping region, and superimposing the unified LiDAR coordinates and ultrasonic radar coordinates into the in the grids.

32. The electronic device according to claim 31, wherein the fusing the superimposed LiDAR coordinates and ultrasonic radar coordinates comprises:
judging that a grid having the LiDAR coordinates as well as ultrasonic radar coordinates is occupied;
judging that a grid only having the ultrasonic radar coordinates is not occupied.

33. The electronic device according to claim 29, wherein the method further comprises:
for a region outside the detection overlapping regions, recognizing the obstacle according to the LiDAR coordinates or ultrasonic radar coordinates, respectively.

34. The electronic device according to claim 27, wherein the method further comprises:
determining a vehicle decision according to the fused obstacle information.

35. A non-transitory computer-readable storage medium storing computer instructions therein, wherein the computer instructions are used to cause the computer to perform an information processing method, wherein the information processing method comprises:
obtaining obstacle information acquired by an ultrasonic radar and a LiDAR respectively;
fusing the obstacle information acquired by the LiDAR with the obstacle information acquired by the ultrasonic radar.

36. The non-transitory computer-readable storage medium according to claim 35, wherein
the ultrasonic radar is mounted at the front of a vehicle body of the driverless vehicle and used to detect obstacle information in front of and laterally in front of the vehicle;
the LiDAR is mounted at the front of the vehicle body of the driverless vehicle and used to detect the obstacle information in front of and laterally in front of the vehicle.

37. The non-transitory computer-readable storage medium according to claim 35, wherein the fusing the obstacle information acquired by the LiDAR with the obstacle information acquired by the ultrasonic radar comprises:
unifying coordinates in a LiDAR coordinate system and coordinates in an ultrasonic radar coordinate system into a reference coordinate system;
superimposing the unified LiDAR coordinates and ultrasonic radar coordinates in a gridded detection overlapping region;
fusing the superimposed LiDAR coordinates and ultrasonic radar coordinates to determine an obstacle recognition result.

38. The non-transitory computer-readable storage medium according to claim 35, wherein the reference coordinate system is a geodetic coordinate system or a vehicle coordinate system.
